(19) United States
(12) Patent Application Publication
(10) Pub. No.: US 2010/0270949 A1
(43) Pub. Date: Oct. 28, 2010

(54) ELECTRONIC BALLAST WITH INPUT VOLTAGE FAULT CONTROL

(76) Inventors: Naoki ONISHI, Kobe (JP); Hiroyuki ASANO, Kashiba (JP); Tetsuya HAMANA, Nara (JP); Masahiro YAMANAKA, Otsu (JP)

Correspondence Address: WADDEY & PATTERSON, P.C., 1600 DIVISION STREET, SUITE 500, NASHVILLE, TN, 37203, US

(21) Appl. No.: 12/767,528

(22) Filed: Apr. 26, 2010

(30) Foreign Application Priority Data
Apr. 24, 2009 (JP) 2009-107071

(51) Int. Cl. H05B 37/02

(52) U.S. Cl. 315/307

(57) ABSTRACT

An electronic ballast includes circuitry to prevent a switch from being damaged in the case where an abnormality occurs in an output voltage of an input power supply. A DC power supply control circuit has a zero current detection circuit that, when a current through an inductor becomes equal to or less than a predetermined current value, outputs a zero signal. A peak current detection circuit, when current through a switch the DC power supply circuit becomes equal to or greater than the predetermined current value, outputs a peak signal. A first drive circuit turns on the switch according to the zero signal, and turns off the switch Q1 according to the peak signal. The zero current detection circuit is provided with a mask circuit that stops the zero signal from being outputted to the first drive circuit for a predetermined period after the current through the inductor has become equal to or less than the predetermined current value.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: Japan Patent Application No. 2009-107071, filed Apr. 24, 2009.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to electronic ballasts that supply operating power to a load such as a gas discharge lamp.

Conventional electronic ballasts convert a DC voltage from a DC power supply or an AC voltage from an AC power supply to a DC voltage having a desired magnitude, and further convert the DC voltage to a high frequency voltage to supply operating power to a load such as a gas discharge lamp. Many such ballasts use a DC power supply circuit including a step-up or boost chopper circuit that can insure a stable output voltage over a wide range of input power supply voltages, and that improve power factor and distortion of the input current waveform.

The basic operation of conventional DC power supply circuit for an electronic ballast will include storage and release of energy in an inductor by repeated switching operation of a switch. The released energy is supplied to a load circuit including a discharge lamp through a diode and a smoothing capacitor. The inductor is connected such that energy is stored when the switch is on. A control or driver circuit turns off the switch when the detected value of current through the switch reaches a predetermined value. The predetermined value at which the switch is turned off is determined by detecting an output voltage of the step-up chopper circuit and feedback-controlling the detected voltage with use of an error amplifier. Also, the time at which the switch is turned on is determined by detecting, with a zero current detection circuit, the time at which the inductor releases its stored energy.

In the zero current detection circuit, the time at which the inductor releases the stored energy is detected by providing a secondary winding on the inductor and monitoring the voltage across the secondary winding. That is, the polarity of the voltage generated across the secondary winding is reversed between the storage and release of energy in and from the inductor. Therefore, for example, if the secondary winding is connected such that a negative voltage is generated at the time of energy storage, the generated voltage is immediately reversed to a positive voltage at the time of energy release, and after the energy release, the positive voltage transitions to a voltage of approximately 0 V. Therefore, by monitoring the voltage around 0 V when the positive voltage falls, the time at which the stored energy in the inductor is released can be detected.

Meanwhile, in the case where the output voltage of an input power supply in the DC power supply circuit is, for example, 100 V-200 V, i.e., the output voltage of the input power supply is a high voltage, the predetermined value of the current through the switch at the time when the switch is switched from on to off is set lower. This will enable the control such that, in the case of an output voltage of 200 V, the conduction period of the switch is shorter than that for the case of the output voltage of 100 V.

On the other hand, the diode in the DC power supply circuit has a reverse recovery time during which current flows in a reverse direction for a short time (due to charge carriers stored during a forward bias period) when the bias is changed from a forward bias to a reverse bias. Accordingly, when the switch is switched from off to on, a relatively large current may be supplied from the smoothing capacitor to the switch during the reverse recovery time of the diode.

In a conventional step-up or boost chopper circuit, if the output voltage of the input power supply is temporarily reduced, sufficient energy is not stored in the inductor even if the switch is turned on. However, as described above, the predetermined value of the current through the switch is set lower, and therefore by erroneously detecting the current during the reverse recovery time of the diode as the switching current through the switch, the switch is turned off with energy storage in the inductor being insufficient. As a result, because energy stored in the inductor is insufficient, the stored energy is immediately released, and the zero current detection circuit having detected the release, turns on the switch. For this reason, if the abnormality of the input power supply continues, the switch may repeat on/off switching in a very short period, specifically, on a nanosecond basis, which may thermally damage the switch due to an increase in switching losses.

### BRIEF SUMMARY OF THE INVENTION

The present invention is made in consideration of the above-described issue and has as one objective to provide a ballast that can prevent a switch from being damaged when an abnormality occurs in the output voltage of the input power supply.

According to a first aspect of the present invention, an electronic ballast includes a DC power supply circuit that has at least one inductor and a switch connected in series with the inductor, and by turning the switch on and off to repeat storage and release of energy in the inductor, converts a ripple voltage to a DC voltage, the ripple voltage being a rectified DC voltage from a DC power supply or a rectified AC voltage from a AC power supply. The ballast further includes a load circuit that receives an output voltage from the DC power supply circuit to supply operating power to a load, and an output voltage detection circuit that detects the output voltage from the DC power supply circuit. A DC power supply control circuit turns the switch on and off in the DC power supply circuit according to a result of the detection in the output voltage detection circuit, and thereby controls the output voltage of the DC power supply circuit to a voltage having a predetermined magnitude.

The DC power supply circuit has a zero current detection circuit that, upon current through the inductor becoming equal to or less than a predetermined current value, outputs a zero signal, a peak current detection circuit that, upon a current through the switch of the DC power supply circuit becoming equal to or more than the predetermined current value, outputs a peak signal, and a drive circuit that turns on the switch of the DC power supply circuit according to the zero signal, and turns off the switch of the DC power supply circuit according to the peak signal. The zero signal detection circuit includes a mask circuit that stops the zero signal from being outputted to the drive circuit for a predetermined period after the current through the inductor has become equal to or less than the predetermined current value.

According to a second aspect of the present invention, the DC power supply control circuit further includes a filter circuit that stops the peak signal from being outputted to the drive circuit for a predetermined period after the current through the switch of the DC power supply circuit has become equal to or greater than the predetermined current value, and the predetermined period set by the mask circuit is set to be longer than the predetermined period set by the filter circuit.

According to a third aspect of the present invention, the load can be a gas discharge lamp, and the load circuit includes an inverter control circuit that has at least one switch and turns the switch on and off to convert the output voltage of the DC power supply circuit to a high frequency voltage. A voltage reduction detection circuit is provided in the DC power supply control circuit and determines whether or not the output voltage of the DC power supply circuit falls below a predetermined lower voltage lower than the predetermined voltage. A sequence control circuit performs at least sequence control of two periods or operational modes, the two modes being a starting period for controlling the inverter control circuit so as to supply power necessary for starting of the discharge lamp, and a lighting period for controlling the inverter control circuit so as to supply power necessary to maintain stable lighting to the discharge lamp, wherein upon the detection that the output voltage falls below the predetermined lower voltage being made in the voltage reduction detection circuit, the sequence control circuit changes to the starting period, and transitions to the lighting period after a predetermined time has passed.

According to a fourth aspect of the present invention, the DC power supply control circuit further includes a voltage rise detection circuit that determines whether or not the output voltage from the DC power supply circuit exceeds a first predetermined over-voltage that is higher than the predetermined voltage, and upon the detection that the output voltage exceeds the first predetermined over-voltage, turns off the switch in the DC power supply control circuit through the drive circuit. A restart circuit times the off time of the switch in the DC power supply control circuit, and upon the elapsed time exceeding a predetermined period, turns on the switch of the DC power supply control circuit through the drive circuit, wherein the voltage rise detection circuit determines, upon the switch of the DC power supply circuit being in an off state, whether or not the output voltage of the DC power supply circuit falls below a second predetermined over-voltage lower than the first predetermined over-voltage. The restart circuit times the off time of the switch of the DC power supply control circuit from a time point when the detection that the output voltage of the DC power supply circuit falls below the second predetermined over-voltage is made in the voltage rise detection circuit.

According to the first aspect of the present invention, in the case where the output voltage is temporarily reduced, and sufficient energy is not stored in the inductor, the switch of the DC power supply circuit can be prevented from being immediately turned on. Accordingly, in the case where an abnormality occurs in the output voltage of the input power supply, the switch of the DC power supply circuit can be prevented from being turned on/off in a very short period, and therefore from being thermally damaged due to an increase in switching losses.

According to the second aspect of the present invention, without use of a one shot pulse generation circuit that generates a one shot pulse when stored energy of the inductor is released, and uses the one shot pulse to turn on the switch, there can be prevented rapid or unnecessary switching that may occur when the switch of the DC power supply circuit is turned off, and therefore the circuit configuration can be simplified.

According to the third aspect of the present invention, by passing through the starting period once when the output voltage of the DC power supply circuit is reduced to fall below the predetermined lower voltage, even if the discharge lamp goes out, a sufficient starting voltage is applied to the discharge lamp if the output voltage of the DC power supply circuit is restored.

According to the fourth aspect of the present invention, it is only necessary to time the predetermined period in the restart circuit from the point in time when the output voltage falls to around the target predetermined voltage during shut down of the DC power supply control circuit, and therefore the predetermined period can be made significantly shorter as compared with the conventional case where the timing is performed in the restart circuit from the shutdown time of the operation of the DC power supply control circuit. Accordingly, an electronic component such as a capacitor, which sets the predetermined period, can be small, and therefore a chip area can be reduced to miniaturize the restart circuit.

### BRIEF DESCRIPTION OF THE SEVERAL VIEWS OF THE DRAWINGS

FIG. 1 is a circuit diagram illustrating a first embodiment of an electronic ballast according to the present invention.

FIG. 2 is a circuit diagram illustrating a starting circuit, a control power supply comparison circuit, and a first control power supply generation circuit according to a first embodiment of the invention.

FIGS. 3(a) to 3(g) are timing charts illustrating operation of a control circuit according to a first embodiment.

FIG. 4 is a circuit diagram illustrating an inverter control circuit according to a first embodiment.

FIGS. 5(a) to 5(g) are timing charts for describing sequence control of a first embodiment of the invention.

FIG. 6 is a circuit diagram illustrating a shutdown circuit used in a first embodiment of the invention.

FIG. 7 is a flowchart describing basic operation of an operation or mode control circuit of a first embodiment.

FIG. 8 is a circuit diagram illustrating a zero current detection circuit of a first embodiment.

FIGS. 9(a) to 9(f) are timing charts describing operation of the zero current detection circuit of the first embodiment.

FIG. 10 is a circuit diagram of a zero current detection circuit for use in a second embodiment of the electronic ballast according to the present invention.

FIG. 11 is a circuit diagram illustrating a filter circuit used in a second embodiment.

FIGS. 12(a) to 12(e) are timing charts describing operation of the zero current detection circuit of the second embodiment.

FIG. 13 is a circuit diagram illustrating a third embodiment of an electronic ballast according to the present invention.

FIG. 14 is a circuit diagram illustrating a voltage reduction detection circuit used in a third embodiment.

FIGS. 15(a) to 15(f) are timing charts describing operation of the voltage reduction detection circuit of the third embodiment in a case where the output voltage is temporarily reduced.

FIGS. 16(a) to 16(f) are timing charts describing operation of the voltage reduction detection circuit of the third embodiment in a case where the output voltage is continuously reduced.

FIG. 17 is a flowchart describing abnormality detection processing according to a third embodiment of the invention.

FIG. 18 is a circuit diagram illustrating a fourth embodiment of an electronic ballast according to the present invention.

FIG. 19 is a circuit diagram illustrating a voltage rise detection circuit according to a fourth embodiment of the invention.

FIGS. 20(a) to 20(d) are timing charts for describing operation of the voltage rise detection circuit and the restart circuit according to a fourth embodiment of the invention.

### DETAILED DESCRIPTION OF THE INVENTION

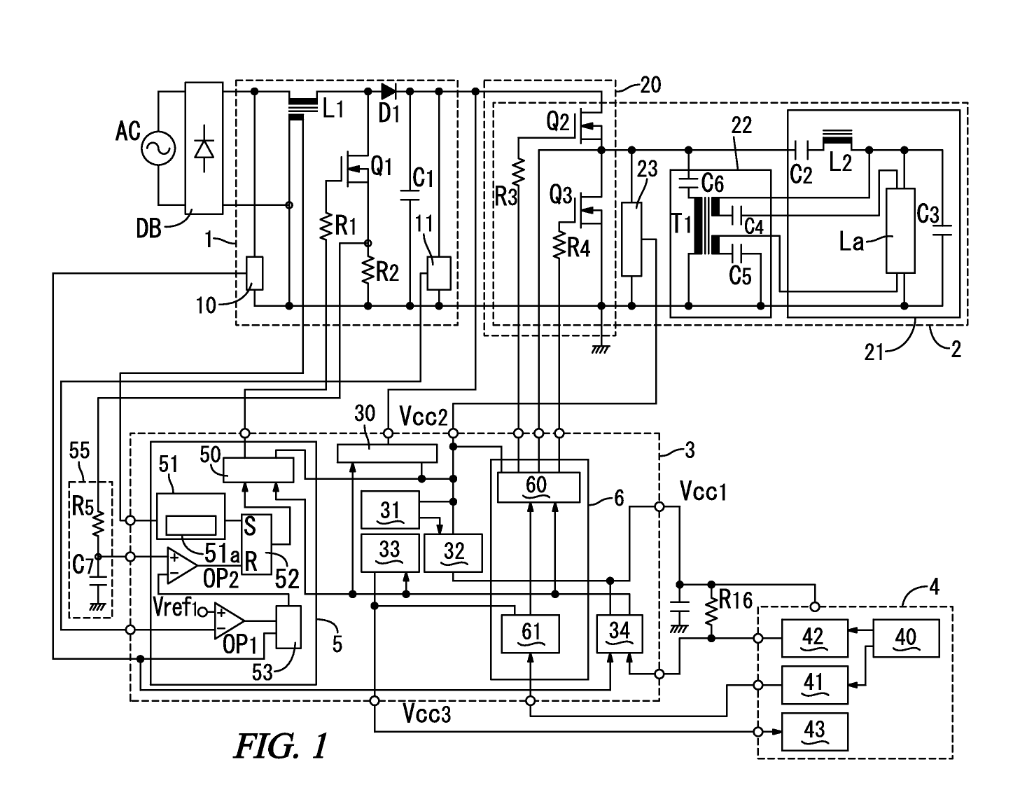

A first embodiment of a electronic ballast according to the present invention is described below with reference to FIG. 1 of the drawings. In the present embodiment, as will be described later, a load circuit 2 includes an inverter circuit 20 that converts a DC voltage from a DC power supply circuit 1 to a high frequency voltage. A resonant circuit 21 receives the high frequency voltage from the inverter circuit 20 to light the discharge lamp La by resonance action. The load circuit 2 is configured to supply lighting power to the discharge lamp La. However, the load circuit 2 is not limited to the illustrated embodiment but may be configured to supply operating power to a load (for example, in the case of an illumination light source, a light emitting diode, or the like) other than a discharge lamp La.

The present embodiment further includes, as shown in FIG. 1, a rectifier circuit DB including a diode bridge that rectifies an AC voltage from an AC power supply AC to output a ripple voltage and a DC power supply circuit 1 that boosts and smoothes the ripple voltage from the rectifier circuit DB to output a bulk DC voltage. The load circuit 2 converts a bulk DC voltage from the DC power supply circuit 1 to the high frequency voltage, and applies the high frequency voltage to light the discharge lamp La. A ballast control circuit 3 is configured such that a DC power supply control circuit 5 controls the DC power supply circuit 1, and an inverter control circuit 6 controls the inverter circuit 20 of the load circuit 2. In one embodiment, both DC power supply control circuit 5 and inverter control circuit 6 may be formed on the same semiconductor substrate, and may further include an operation setting or mode control circuit 4 for setting or controlling an operational mode in the control circuit 3.

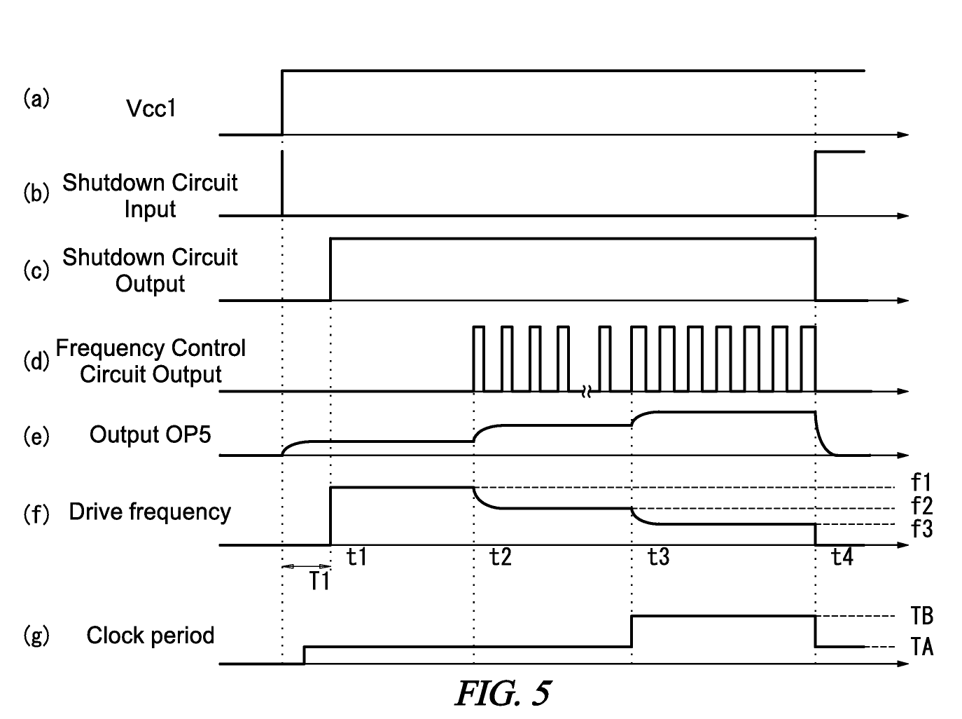

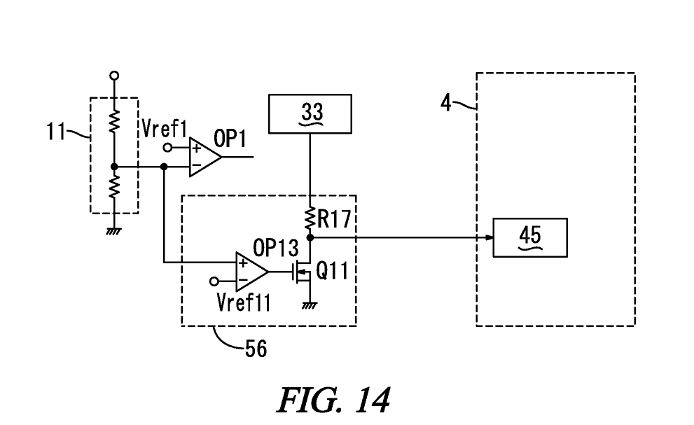

The DC power supply circuit 1 can be a step-up or boost chopper circuit including an inductor L1, a switch Q1, a diode D1, and a smoothing capacitor C1. The switch Q1 is turned on/off according to a drive signal from DC power supply control circuit 5 to thereby boost the ripple voltage from rectifier circuit DB, and to supply to the load circuit 2 the DC voltage formed by smoothing the stepped-up ripple voltage. On an input side of the DC power supply circuit 1, there is provided an input voltage detection circuit 10 for detecting the input voltage of the DC power supply circuit 1, and on an output side, there is provided an output voltage detection circuit 11 for detecting the output voltage of the DC power supply circuit 1. The switch Q1 may be a MOSFET, of which the gate is connected to first drive circuit 50 through resistor R1. The source of the switch Q1 is connected to a resistor R2, and the voltage drop across the resistor R2 is provided to a non-inverting input of a second operational amplifier OP2 through a filter circuit 55, including a resistor R5 and a capacitor C7. The filter circuit 55 prevents the switch Q1 from being turned off due to a current spike at the time when the switch Q1 is turned on. The input voltage detection circuit 10 and the output voltage detection circuit 11 may include a resistor and a capacitor (see FIG. 5 for the input voltage detection circuit 10, and FIG. 14 for the output voltage detection circuit 11), and is widely known, and therefore detailed description is omitted here.

The load circuit 2 may include an inverter circuit 20 that has a pair of series-connected inverter switches Q2 and Q3. The drive signal from the inverter control circuit 6 alternately turns the switches Q2 and Q3 on and off to convert the DC voltage from the DC power supply circuit 1 to the high frequency voltage. The resonant circuit 21 includes capacitors C2 and C3 and an inductor L2, and couples the high frequency voltage from the inverter circuit 20 to light the discharge lamp La by resonance action. A preheating circuit 22 includes capacitors C4, C5, and C6, and transformer T1 and applies the high frequency voltage from the inverter circuit 20 to preheat the discharge lamp La. A control power supply generation circuit 23 receives the high frequency voltage from the inverter circuit 20 to generate a second control power supply voltage Vcc2. The switches Q2 and Q3 may be MOSFETs. Resistors R3 and R4 are respectively connected between the gates of switches Q2 and Q3 and a second drive circuit 60.

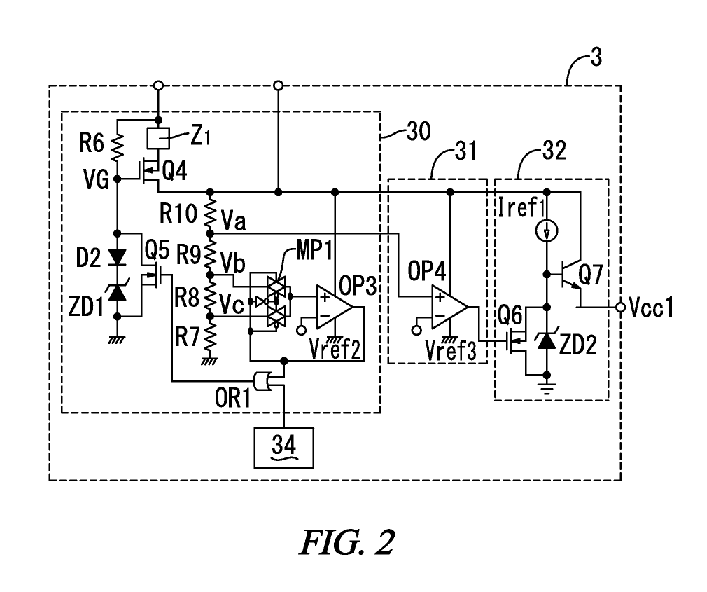

The control circuit 3 may include a starting circuit 30 that receives the output voltage from the DC power supply circuit 1 to provide the second control power supply voltage Vcc2, a control power supply comparison circuit 31 that compares the second control power supply voltage Vcc2 with a third reference voltage Vref3 (FIG. 2), a first control power supply generation circuit 32 that generates a first control power supply voltage Vcc1 according to a result of the comparison in the control power supply comparison circuit 31, a third control power supply generation circuit 33 that generates a third control power supply voltage Vcc3 according to an output from a shutdown circuit 34, and a shutdown circuit 34 that controls operation of the first and second drive circuits 50 and 60 according to a detection result in a shutdown detection circuit 42.

The operation or mode control circuit 4 may be a microprocessor, which may include a sequence control circuit 40 that performs sequence control of frequency control circuit 41 and the shutdown detection circuit 42. The frequency control circuit 41 outputs a frequency control signal for controlling the drive frequency of the switches Q2 and Q3 of the inverter circuit 20. The operation or mode control circuit 4 may further include a shutdown detection circuit 42 that outputs a shutdown signal to terminate operation of the first drive circuit 50 and the second drive circuit 60 according to the sequence control by the sequence control circuit 40, and a period setting circuit 43 that sets a clock period of the mode control circuit 4.

The DC power supply control circuit 5 may include a first drive circuit 50 that outputs a drive signal that turns switch Q1 of the DC power supply circuit 1 on and off, and a zero current detection circuit 51 that outputs a zero signal if current through the inductor L1 via secondary winding of the inductor L1 of the DC power supply circuit 1 becomes equal to or less than a predetermined current value. An RS flip-flop 52 controls operation of the first drive circuit 50. A first operational amplifier OP1 compares the detection voltage of the output voltage detection circuit 11 with a first reference voltage Vref1. A multiplier circuit 53 multiplies the detection voltage of the input voltage detection circuit 10 by the output voltage of the first operational amplifier OP1. A second operational amplifier OP2 compares the voltage drop across resistor R2 of the DC power supply circuit 1 and the output voltage from the multiplier circuit 53. The first and second operational amplifiers OP1 and OP2 and the multiplier circuit 53 constitute a peak current detection circuit that outputs a peak signal when current through the switch Q1 becomes equal to or greater than the predetermined current value.

The inverter control circuit 6 may include a second drive circuit 60 that outputs the drive signal that alternately turns switches Q2 and Q3 of the inverter circuit 20 on and off, and a variable frequency circuit 61 that can vary the frequency of the drive signal according to the frequency control signal outputted from the frequency control circuit 41 of the mode control circuit 4.

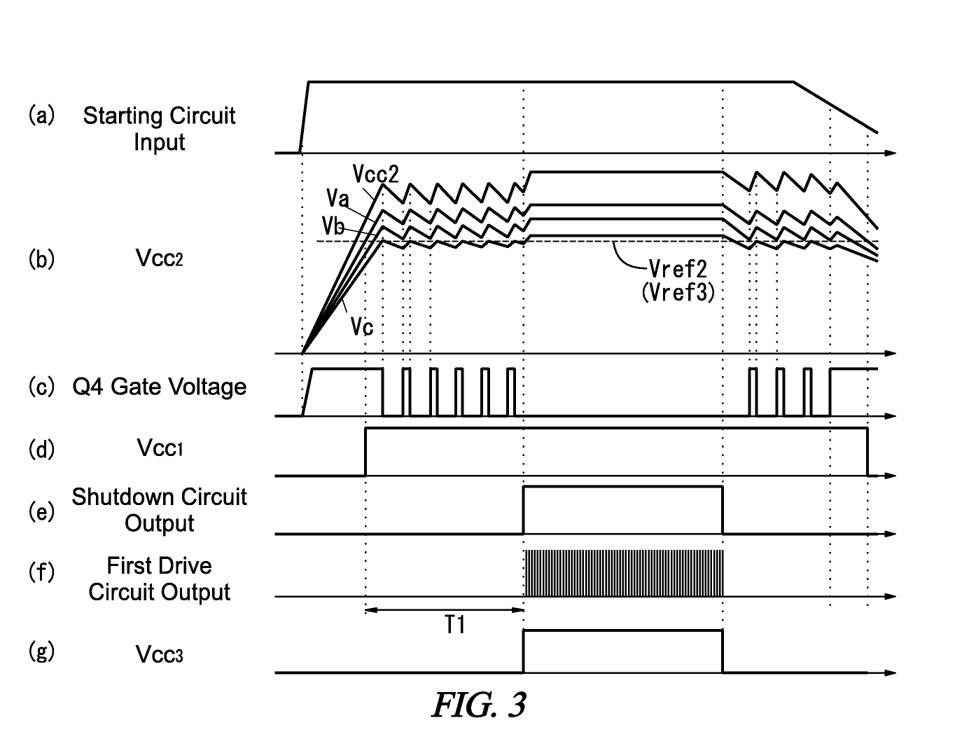

Operation of the control circuit 3 of present embodiment may be described by reference to FIGS. 2 and 3. When the ballast is powered on, the output voltage of the DC power supply circuit 1 is coupled to the load circuit 2 and to the starting circuit 30 of the control circuit 3. Immediately after power-on, the output voltage of the DC power supply circuit 1 is a smoothed voltage formed by smoothing the AC voltage of the AC power supply AC with the smoothing capacitor C1. The smoothed voltage supplies current to a series circuit of a diode D2 and a zener diode ZD1 through a high voltage resistor R6. Voltage VG generated across the series circuit is provided to the gate of switch Q4, which may be a high voltage MOSFET. Thereby, switch Q4 is turned on to activate the second control power supply voltage Vcc2. Then, the second control power supply voltage Vcc2, and the detection voltages Va, Vb, and Vc rise with time (see FIGS. 3(a) and (b)).

The second control power supply voltage Vcc2 is divided into detection voltages Va, Vb, and Vc (Va>Vb>Vc) by a series circuit including resistors R7, R8, R9, and R10 (FIG. 2). The detection voltage Va is coupled to the non-inverting input of fourth operational amplifier OP4 in the control power supply comparison circuit 31, and compared with the third reference voltage Vref3 provided to the inverting input. The detection voltages Vb and Vc are coupled to non-inverting input of third operational amplifier OP3 through a first multiplexer circuit MP1 having a pair of transfer gate elements connected with the respective voltages. The output from third operational amplifier OP3 and the output from shutdown circuit 34 are coupled to OR gate OR1. The output of OR gate OR1 controls on/off switching of switch Q5, which may be a MOSFET connected in parallel with the series circuit of diode D2 and zener diode ZD1. Immediately after power-on, the output from shutdown circuit 34 is at a low level, and therefore switching of switch Q5 is controlled only by the output from third operational amplifier OP3.

At the beginning of starting of the second control power supply voltage Vcc2, the detection voltage Vc is provided to the non-inverting input of third operational amplifier OP3 through the first multiplexer circuit MP1, and compared with the second reference voltage Vref2 that is coupled to the inverting input. When the detection voltage Vc equals the second reference voltage Vref2, the output of third operational amplifier OP3 is inverted, and detection voltage Vb is provided to the non-inverting input of third operational amplifier OP3 through the first multiplexer circuit MP1. At the same time, the output from third operational amplifier OP3 is provided to the gate of switch Q5 through the OR gate OR1 to thereby turn on switch Q5 and turn off switch Q4 (see FIGS. 3 (b) and (c)).

By switching off switch Q4, the second control power supply voltage Vcc2 and detection voltages Va, Vb, and Vc are reduced. When the detection voltage Vb is equal to the second reference voltage Vref2, the output of third operational amplifier OP3 is inverted, and the detection voltage Vc is again coupled to the non-inverting input of third operational amplifier OP3 through the first multiplexer circuit MP1. Also, along with the inversion of the output of third operational amplifier OP3, switch Q5 is turned off, and switch Q4 is turned on. Accordingly, the second control power supply voltage Vcc2 and the detection voltages Va, Vb, and Vc again start to rise. The operation is repeated, and thereby the gate voltage of switch Q4 is controlled as illustrated in FIG. 3(c), and repeats on/off.

Also, the second control power supply voltage Vcc2 is provided to the collector terminal of switch Q7, which may be a bipolar transistor, in the first control power supply generation circuit 32. The first control power supply generation circuit 32 is configured to have switch Q7, a first constant current source Iref1 connected between the collector terminal and base terminal of switch Q7, a zener diode ZD2 connected in series with the first constant current source Iref1, and a switch or MOSFET Q6 connected in parallel with zener diode ZD2. The gate of switch Q6 is connected with an output from fourth operational amplifier OP4 in the control power supply comparison circuit 31. Thus, the second control power supply voltage Vcc2 rises, and when the detection voltage Va exceeds third reference voltage Vref3, switch Q7 is turned on to activate the first control power supply voltage Vcc1, which is supplied to the mode control circuit 4 (see FIGS. 3(b) and (d)). Note that the third reference voltage Vref3 is equal in magnitude to that of the second reference voltage Vref2.

After a predetermined period T1 has elapsed after starting of the first control power supply voltage Vcc1, a high level signal is outputted from the shutdown circuit 34 (see FIG. 3 (e)), and upon receipt of the high level signal, the third control power supply voltage Vcc3 is generated in the third control power supply generation circuit 33 (see FIG. 3 (g)). In addition, the first drive circuit 50 of the DC power supply control circuit 5 is supplied with third control power supply voltage Vcc3, and thereby starts to operate (see FIG. 3 (f)). Further, the third control power supply voltage Vcc3 is also supplied to the inverter control circuit 6, which starts to operate at the same time as that of the first drive circuit 50. Thus, the inverter circuit 20 starts to operate. Details of the operation or mode control circuit 4 will be described below.

The inverter circuit 20 starts to operate, and thereby the second control power supply voltage Vcc2 is supplied to the control circuit 3 from the control power supply generation circuit 23. For this reason, the detection voltages Vb and Vc constantly exceed the second reference voltage Vref2, and switch Q4 is maintained in an off state (see FIGS. 3 (b) and (c)). Note that, in the present embodiment, to reliably maintain the off-state of switch Q4, on/off control of switch Q4 is performed with the outputs of third operational amplifier OP3 and the shutdown circuit 34. That is, during operation of the inverter circuit 20, the output of shutdown circuit 34 is constantly at a high level, and therefore even if the second control power supply voltage Vcc2 is reduced to invert the output of third operational amplifier OP3, the off-state of the switch Q4 is maintained.

In addition, if operation of inverter circuit 20 is disabled, the supply voltage from control power supply generation circuit 23 is reduced, by which the detection voltage Vb falls below the second reference voltage Vref2, and thereby switch Q4 again repeats on/off operation (see FIGS. 3(b) and (c)). The on/off operation continues if the smoothed output voltage from DC power supply circuit 1 is large enough.

Note that the control power supply generation circuit 23 may have any configuration that can generate the second control power supply voltage Vcc2 according to the switching operation in the inverter circuit 20, and is only required to generate a power supply voltage equal to or greater than 10 V so as to be able to drive the respective switches Q1 to Q3.

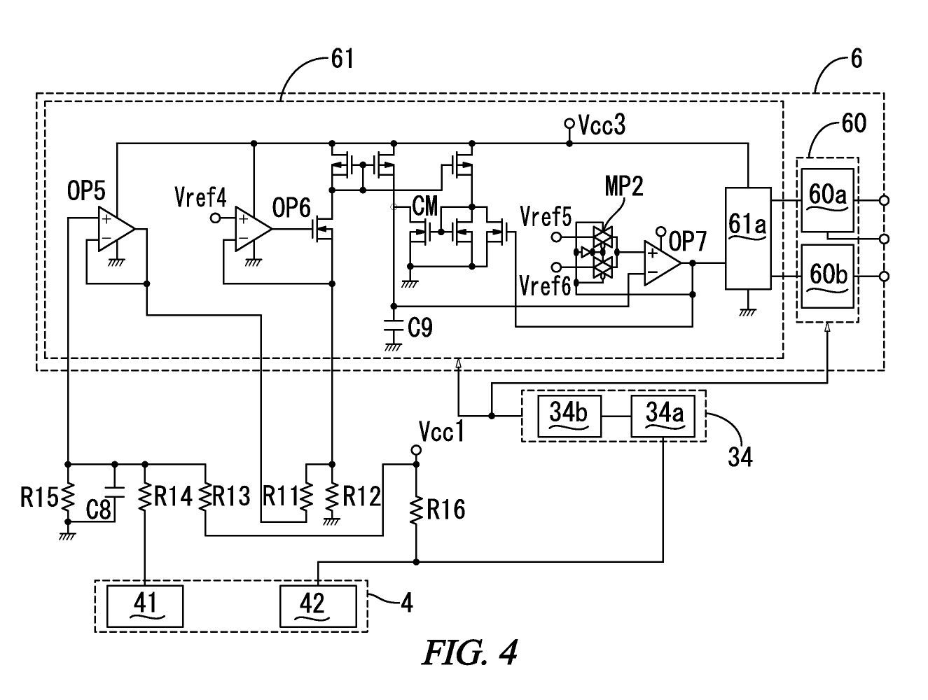

The variable frequency circuit 61 is described with reference to FIG. 4, and includes a current mirror circuit CM that has a constant voltage circuit including a fifth operational amplifier OP5, a load impedance circuit including resistors R11 and R12 connected to an output of fifth operational amplifier OP5, and a sixth operational amplifier OP6 of which a non-inverting input is connected with a fourth reference voltage Vref4, and adjusts the current through capacitor C9 according to current through the load impedance circuit. An oscillation circuit includes a second multiplexer circuit MP2 having a pair of transfer gate elements respectively connected to a fifth reference voltage Vref5 and a sixth reference voltage Vref6, and a seventh operational amplifier OP7 that compares the output voltage of the second multiplexer circuit MP2 with the voltage across capacitor 9. A dead time generation circuit 61a generates a dead time for preventing switches Q2 and Q3 of the inverter circuit 20 from being simultaneously turned on.

A non-inverting input of fifth operational amplifier OP5 is coupled to the frequency control signal from the frequency control circuit 41 of the mode control circuit 4 through a filter circuit including resistors R13, R14, and R15, and capacitor C8. The frequency control signal is, for example, a rectangular wave signal having a predetermined duty ratio as illustrated in FIG. 5(d), and is converted to a DC signal corresponding to the duty ratio in the filter circuit. The output of fifth operational amplifier OP5 is connected to the output of sixth operational amplifier OP6 through resistor R11, and therefore by varying the duty ratio of the frequency control signal, the current from the output of fifth operational amplifier OP5 to the output of sixth operational amplifier OP6 varies. Also, by varying the duty ratio of the frequency control signal, current through capacitor C9 can be varied to vary the drive frequency of the drive signal.

In addition, the drive signal is supplied to high side drive circuit 60a and low side drive circuit 60b of second drive circuit 60 through dead time generation circuit 61a. The respective high and low side drive circuits 60a and 60b control on/off switching of switches Q2 and Q3.

The DC power supply control circuit 5 is described with reference to FIG. 1. The DC power supply control circuit 5 is a circuit that repeats the storage and release of energy in inductor L1 by controlled switching of switch Q1. The switch Q1 is turned on at the energy release from the inductor L1. For this purpose, the DC power supply control circuit 5 is provided with a zero current detection circuit 51, and by detecting the time at which a secondary winding voltage of the inductor L1 falls to around 0 V in the zero current detection circuit 51, the timing of the energy released from the inductor L1, i.e., timing at which the current through the inductor L1 becomes equal to or less than the predetermined current value, is determined. If it is determined in the zero current detection circuit 51 that energy is released from the inductor L1, the set terminal of RS flip-flop 52 is provided with a high level signal to turn on switch Q1 through first drive circuit 50. Details of the zero current detection circuit 51 will be described below.

When switch Q1 is on, the current through switch Q1 is detected by the resistor R2, and the voltage drop across resistor R2 and the output voltage of the multiplier circuit 53 are compared by second operational amplifier OP2. If the voltage across resistor R2 exceeds the output voltage from multiplier circuit 53, i.e., if the current through switch Q1 exceeds a predetermined value, a reset terminal of RS flip-flop 52 is supplied with a high level signal (peak signal) to turn off switch Q1 through first drive circuit 50. The predetermined value is determined by comparing the detection voltage from the output voltage detection circuit 11 of the DC power supply circuit 1 with the first reference voltage Vref1 in first operational amplifier OP1, and performing feedback control.

The timing chart of FIG. 5 can be used to describe the sequence control of the present embodiment. Conventional sequence control of a lamp preheating period during which the filaments of discharge lamp La are preheated, a starting period during which to activate or start the discharge lamp La, a resonant action is used to apply a high voltage to the discharge lamp La, and a lighting period during which the discharge lamp La is lighted with a desired output. In the present embodiment, the mode control circuit 4 is used to perform the sequence control.

As illustrated in FIG. 5(a), when the first control power supply voltage Vcc1 is activated to supply the power supply voltage to mode control circuit 4, an input signal to shutdown circuit 34 is high at the moment of the starting of the first control power supply voltage Vcc1 and then becomes low (see FIG. 5(b)). Also, during a predetermined period T1 before the output of shutdown circuit 34 becomes high, operation of variable frequency circuit 61, first drive circuit 50, and second drive circuit 60 is stopped.

When the microprocessor that includes mode control circuit 4 is supplied with first control power supply voltage Vcc1, a preset initial starting program operates to assign a function to a microprocessor terminal. However, at this time, the impedance of the terminal may become infinite. For this reason, in the present embodiment, a resistor R16 is connected between the first control power supply voltage Vcc1 and an output of the shutdown detection circuit 42 to prevent the output of the microprocessor terminal from becoming unstable.

After the predetermined period T1 has passed, as illustrated in FIG. 5(c), the shutdown signal from shutdown circuit 34 is high to start operation of variable frequency circuit 61, first drive circuit 50, and second drive circuit 60. The inverter circuit 20 operates at the drive frequency set by frequency control circuit 41. The duty ratio of the frequency control signal output from frequency control circuit 41 is varied during the preheating period from time t1 at which inverter circuit 20 starts to operate to time t2, the starting period from the time t2 to time t3, and the lighting period after time t3. For this reason, the output of fifth operational amplifier OP5 varies as illustrated in FIG. 5(e) along with the variation in duty ratio of the frequency control signal. Accordingly, the drive frequency is sequentially varied, i.e., the frequency f1 during the preheating period, the frequency f2 during the starting period, and the frequency f3 during the lighting period (see FIG. 5(f)). Thus, the discharge lamp La is lit via the preheating period and the starting period.

By setting a time constant of the filter circuit including resistors R13, R14, and R15 and capacitor C8, which is provided in a stage prior to an input of fifth operational amplifier OP5 so as to stabilize the output voltage of the filter circuit during the predetermined period T1, the output voltage of fifth operational amplifier OP5 at the start time of the preheating period is stabilized (see FIG. 5(e)), and therefore the drive frequency can be stabilized.

In addition, the preheating period and the starting period can be determined in the mode control or setting circuit 4, and also timed with a built-in oscillator or timer circuit that is typically incorporated in the microprocessor. Also, in the present embodiment, the program processing speed of the microprocessor is determined on the basis of a clock period set in period setting circuit 43.

Also, the duty ratio of the frequency control signal from the frequency control circuit 41 is 0% during the preheating period, and is first increased during the starting period after the operation of the inverter circuit 20 has been stabilized, so that current consumption in the ballast control circuit 3 and the mode control circuit 4 immediately after the start of the operation of the inverter circuit 20 can be reduced, and the voltages from the respective control power supplies can be stabilized. Further, by setting the shutdown signal from the shutdown detection circuit 42 to a high level (i.e., the input signal to the shutdown circuit 34 to the high level) when operation of the inverter circuit 20 is stopped, current can be prevented from flowing through the resistor R16, and current consumption in the ballast control circuit 3 when the operation of the inverter circuit 20 is shut down can be reduced. In addition, by processing an input/output to/from the microprocessor (mode control circuit 4) on a binary basis, i.e., on the basis of the high and low levels, without use of an A/D or D/A conversion circuit, current consumption in the microprocessor can be significantly reduced. In such a case, stresses on switch Q4 of the starting circuit 30 can also be significantly reduced, and therefore the starting circuit 30 can be miniaturized.

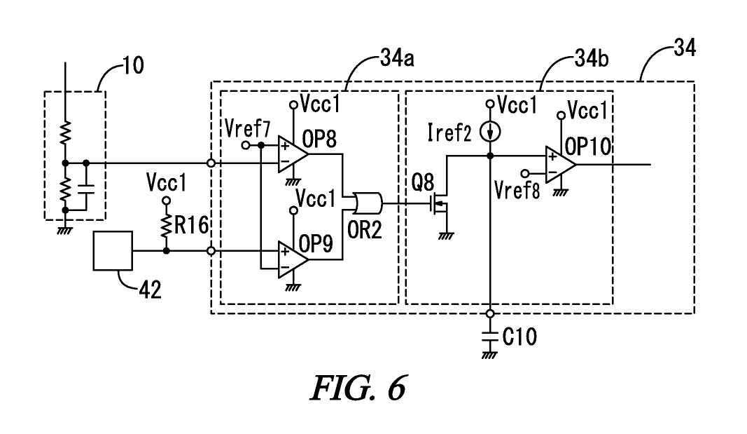

The shutdown circuit 34 is described with reference to FIG. 6. A shutdown signal input circuit 34a is supplied with the detection voltage from input voltage detection circuit 10 and a shutdown signal voltage from the shutdown detection circuit 42. A shutdown timer circuit 34b, upon receipt of an output from the shutdown signal input circuit 34a, measures the time during which operation of variable frequency circuit 61, first drive circuit 50, and second drive circuit 60 are stopped.

The shutdown signal input circuit 34a includes an eighth operational amplifier OP8 of which a non-inverting input is provided with a seventh reference voltage Vref7. The inverting input is supplied with the detection voltage from input voltage detection circuit 10. A ninth operational amplifier OP9 has a non-inverting input supplied with the shutdown signal voltage from the shutdown detection circuit 42 and an inverting input that is coupled to seventh reference voltage Vref7. An OR gate OR2 is connected to the outputs of the respective operational amplifiers OP8 and OP9.

The shutdown timer circuit 34b includes a MOSFET or switch Q8. The gate of switch Q8 is coupled to the output from shutdown signal input circuit 34a. A capacitor C10 is connected to the drain of switch Q8. A second constant current source Iref2 supplies current to capacitor C10. A tenth operational amplifier OP10 has its non-inverting input supplied with the voltage across capacitor C10 and its inverting input coupled to an eighth reference voltage Vref8. Switch Q8 is turned on/off according to the output from shutdown signal input circuit 34a. When switch Q8 is off, capacitor C10 is charged for a charging time that is determined by the current from second constant current source Iref2 and the capacitance of the capacitor C10.

The eighth operational amplifier OP8 outputs a high level signal if the detection voltage from input voltage detection circuit 10 exceeds a predetermined voltage (eighth reference voltage Vref8). On the other hand, ninth operational amplifier OP9 outputs a low level signal if the shutdown signal from shutdown detection circuit 42 is low, whereas if the shutdown signal is high, it outputs a high level signal. Accordingly, only if the detection voltage from input voltage detection circuit 10 is equal to or less than the predetermined voltage, and the shutdown signal from shutdown detection circuit 42 is low, switch Q8 is turned off to charge capacitor C10. Also, if the voltage across capacitor C10 exceeds the predetermined voltage (eighth reference voltage Vref8), a high level signal is outputted from tenth operational amplifier OP10, and as described above, the third control power supply voltage Vcc3 is generated by third control power supply generation circuit 33 to start the operation of variable frequency circuit 61, first drive circuit 50, and second drive circuit 60. That is, the charging time of capacitor C10 corresponds to the predetermined period T1, during which operation of the inverter circuit 20 is stopped.

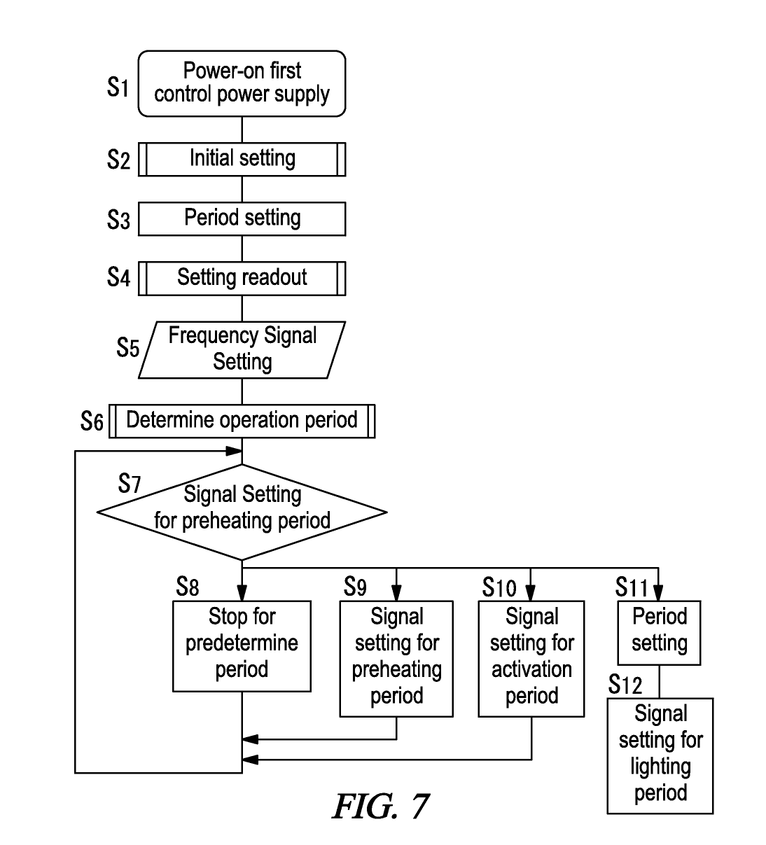

The basic operation of the mode control or operation setting circuit 4 is described with use of a flowchart illustrated in FIG. 7. First, when first control power supply voltage Vcc1 is powered on (S1), the initial starting program operates to make initial settings (S2), and the period setting circuit 43 starts to operate (S3). A clock signal generated in the period setting circuit 43 is used as a basic clock for the microprocessor and mode control circuit 4. In one embodiment, two clock signals respectively having periods TA and TB (TA>TB) are used and are appropriately alternately switched. As the period of the clock signal is decreased, the current consumption in the microprocessor increases, and therefore in this embodiment, the clock signal having the period TA is first used.

The information for the duty ratio of the frequency control signal, which is preliminarily stored, is read (S4) to cause the frequency control signal to be outputted (S5). Subsequently, a timer starts (S6), and on the basis of an elapsed time, an operation period or mode is determined (S7). That is, when the elapsed time reaches time t1, the operation period or mode is determined as the preheating period to set the frequency control signal such that the drive frequency becomes equal to the frequency f1 (S9). When the elapsed time reaches time t2, the operation period or mode is determined as the starting period to set the frequency control signal such that the drive frequency becomes equal to the frequency f2 (S10). When the elapsed time reaches the time t3, the operation period or mode is determined as the lighting period to set the frequency control signal such that the drive frequency becomes equal to the frequency f3 (S12). In addition, during the predetermined period T1 from the starting of the mode control circuit 4 to the time t1, operation of the inverter circuit 20 is shut down (stopped) (S8).

Meanwhile, the present embodiment separately provides a conventionally well-known fault or abnormality detection circuit that detects an abnormality such as whether or not the discharge lamp La is connected normally (not shown), or whether the discharge lamp La is at end of life. The abnormality detection circuit is adapted to disable the control circuit 3 if the abnormality is detected in the abnormality detection circuit during the above operation. As described, in the case where an end of life lamp La is detected, the end of life detection should be immediately operated, particularly during the lighting period of the discharge lamp La.

For this purpose, upon transition to the lighting period or mode, the period of the clock signal is switched to the period TB in the period setting circuit 43 (S11). The present embodiment is adapted such that, by switching the period of the clock signal to the shorter period TB than the period TA as described, the processing speed of the microprocessor is increased to immediately operate the end of life detection. Note that the timing of the period switching is not limited to the time of transfer to the lighting period as described above, but may be any time during a period from the start of the preheating period to the transition to the lighting period, i.e., when the inverter circuit 20 starts to operate to stably supply the second control power supply voltage Vcc2 to the control circuit 3 from the control power supply generation circuit 23.

In the case where the period of the clock signal is the period TB when the abnormality is detected to disable operation of the control circuit 3 as described above, the period of the clock signal is switched to the period TA in the period setting circuit 43 to thereby reduce the current consumption in the operation setting circuit 4. Thus, stresses on the starting circuit 30 can be reduced, and the voltages from the respective control power supplies can be stabilized when the inverter circuit 20 is restarted.

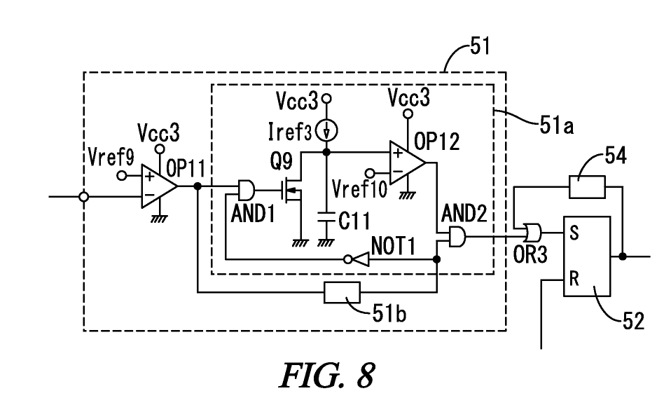

The zero current detection circuit 51 is described with reference to FIG. 8. An eleventh operational amplifier OP11 has its inverting input coupled to the secondary winding voltage of the inductor L1 and its non-inverting input coupled to a ninth reference voltage Vref9. A mask circuit 51a stops or masks the zero signal from the zero current detection circuit 51 during a predetermined period after the release of stored energy of the inductor L1. A one shot pulse generation circuit 51b receives the output from eleventh operational amplifier OP11 to generate a single pulse having an arbitrary width. Also, between the zero current detection circuit 51 and the set terminal of the RS flip-flop 52, an OR gate OR3 is provided. One of inputs of the OR gate OR3 is connected to the output of the zero current detection circuit 51. The other input of OR gate OR3 is connected to the output of restart circuit 54.

The restart circuit 54 times an off time of the switch Q1, and if the off time exceeds a predetermined period (e.g., approximately 100 μs), the restart circuit 54 supplies a high level signal to the OR gate OR3, and thereby inputs the high level signal to the set terminal of the RS flip-flop 52 to turn on switch Q1 through the first drive circuit 50. Note that the one shot pulse generation circuit 51b and the restart circuit 54 are conventionally well known, and detailed description of them is omitted.

The mask circuit 51a includes an AND gate AND1 that is coupled to the output of eleventh operational amplifier OP11 and an output of one shot pulse generation circuit 51b through a NOT gate NOT1. A MOSFET or switch Q9 has its gate coupled to the output of AND gate AND1. A capacitor C11 is connected to the drain of switch Q9. A third constant current source Iref3 supplies current to the capacitor C11. A twelfth operational amplifier OP12 has its non-inverting input supplied with the voltage across capacitor C11 and its inverting input is supplied with a tenth reference voltage Vref10, AND gate AND2 is connected to the output of twelfth operational amplifier OP12 and to the output of one shot pulse generation circuit 51b.

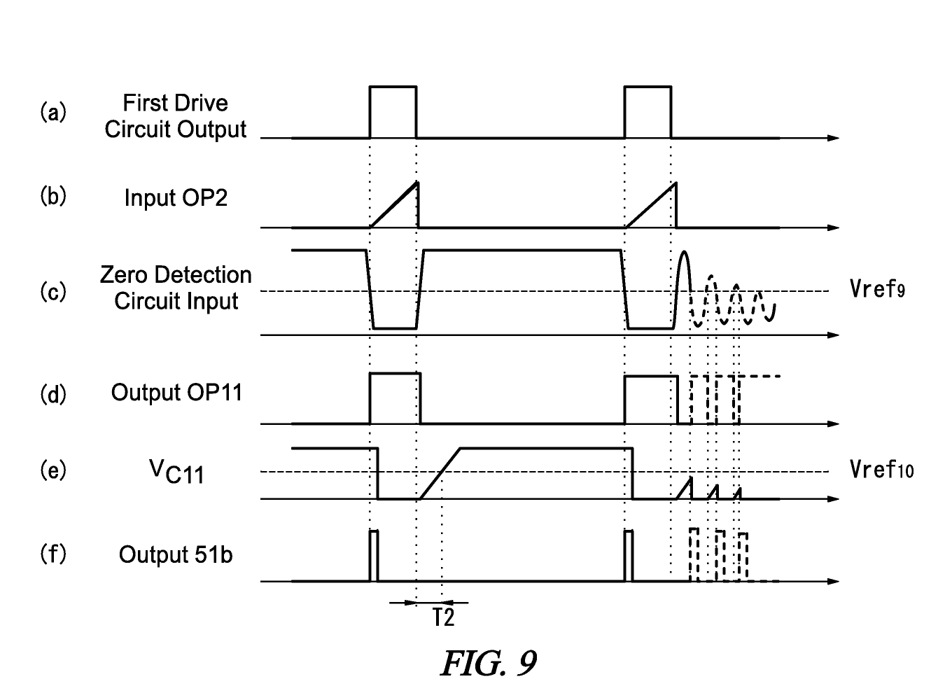

Operation of the zero current detection circuit 51 is described with reference to FIG. 9. First, when switch Q1 is off, stored energy of the inductor L1 is released, i.e., the secondary winding voltage of the inductor L1 falls below ninth reference voltage Vref9, a high level signal is outputted from eleventh operational amplifier OP11, and a one shot pulse is outputted from the one shot pulse generation circuit 51b (see FIGS. 9 (c), (d), and (f)).

Normally, during the off period of switch Q1, switch Q9 is in the off state, so that capacitor C11 is charged by third constant current source Iref3, and because the charge voltage exceeds tenth reference voltage Vref10, a high level signal is outputted from twelfth operational amplifier OP12. Thus, the output of twelfth operational amplifier OP12, and the one shot pulse of the one shot pulse generation circuit 51b bring the output of AND gate AND1 to a high level, and therefore the high level signal is provided to the set terminal of the RS flip-flop 52 to turn on switch Q1 through the first drive circuit 50 (see FIG. 9(a)). Also, after generation of the one shot pulse from the one shot pulse generation circuit 51b, switch Q9 is turned on, and capacitor C11 is discharged (see FIG. 9(e)).

When switch Q1 is turned on, the current through switch Q1 increases, and the input voltage to second operational amplifier OP2 increases. Then, when the input voltage exceeds a predetermined value (output voltage of the multiplier circuit 53), the reset terminal of the RS flip-flop 52 is provided with a high level signal to turn off switch Q1 through the first drive circuit 50 (see FIGS. 9 a) and (b)). When switch Q1 is turned off, the secondary winding voltage of the inductor L1 starts to rise (FIG. 9(c)). Subsequently, when the secondary winding voltage exceeds the ninth reference voltage Vref9, a low level signal is outputted from eleventh operational amplifier OP11 to turn off switch Q9, and charging of capacitor C11 is started (see FIGS. 9(d) and (e)).

The charge voltage of capacitor C11 requires a predetermined period T2 to equal tenth reference voltage Vref10, and during the predetermined period T2, the high level signal is not outputted from twelfth operational amplifier OP12. Accordingly, during the predetermined period T2, the output of AND gate AND2 is constantly low, so that during the period the output of eleventh operational amplifier OP11 is high, and therefore even if the one shot pulse is generated from the one shot pulse generation circuit 51b, the set terminal of the RS flip-flop 52 is not provided with a high level signal. Thus, the mask circuit 51a stops the zero signal (high level signal) from the zero current detection circuit 51 during the predetermined period T2 after switch Q1 has been turned off.

If the output voltage from the AC power supply is temporarily reduced, sufficient energy is not stored in the inductor L1 even if switch Q1 is turned on. For this reason, if switch Q1 is turned off with energy stored in the inductor L1 being insufficient, the stored energy in inductor L1 is insufficient, and is therefore immediately released. The zero current detection circuit 51 detects this condition to turn on switch Q1, and thereby switch Q1 may repeat on/off switching in a very short period to be thermally damaged.

For this reason, the present embodiment may include the mask circuit 51a as described above, and thereby if the output voltage of the AC power supply AC is temporarily reduced, and sufficient energy is not stored in the inductor L1, stops or masks the output of the zero signal from the zero current detection circuit 51 for the predetermined period T2 to prevent switch Q1 from being immediately turned on. Thus, if an abnormality occurs in the output voltage of the AC power supply AC, switch Q1 can be prevented from being turned on/off in a very short period, and thereby from being thermally damaged due to an increase in switching losses. For this reason, a ballast having high reliability with few failures can be achieved.

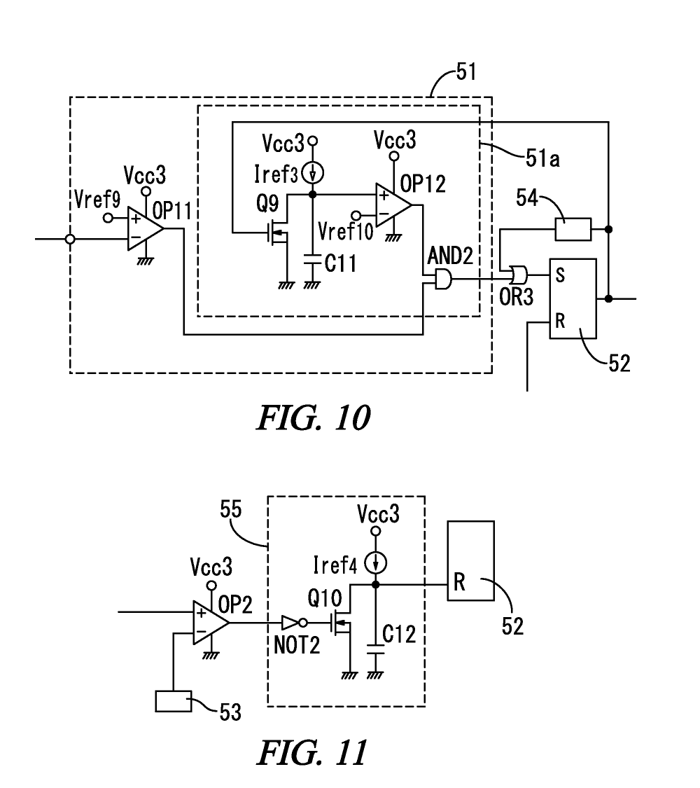

A second embodiment of the electronic ballast according to the present invention is described with reference to FIG. 10. Note that the basic configuration of the present embodiment is in common with the first embodiment, and therefore common circuits are denoted by the same reference numerals to omit description. The present embodiment is, as illustrated in FIG. 10, characterized in that the one shot pulse generation circuit 51b, the AND gate AND1, and the NOT gate NOT1 are not part of the zero current detection circuit 51. Also, the output of eleventh operational amplifier OP11 is directly coupled to AND gate AND2, and the gate of the switch Q9 is coupled with the output of the RS flip-flop 52.

Also, in the first embodiment, the filter circuit 55 is provided in the stage prior to an input of second operational amplifier OP2. However, in the present embodiment, the filter circuit 55 is provided between the output of second operational amplifier OP2 and the reset terminal of the RS flip-flop 52. Further, the filter circuit 55 of the present embodiment includes, as illustrated in FIG. 11, a switch Q10 (MOSFET), having a gate connected with the output of second operational amplifier OP2 through NOT gate NOT2; a capacitor C12 connected to the drain of switch Q10; and a fourth constant current source Iref4 that supplies current to capacitor C12.

In the filter circuit 55, when the output of second operational amplifier OP2 is high, switch Q10 is turned off to charge capacitor C12. Then, when the voltage across capacitor C12 exceeds a predetermined voltage, the reset terminal of the RS flip-flop 52 is provided with a high level signal to turn off switch Q1 through first drive circuit 50. The time necessary to reach the predetermined voltage from the start of charging of the capacitor C12 is defined as a filter period Tf. Note that the filter period Tf is determined by the current from third constant current source Iref3 and the capacitance of the capacitor C12.

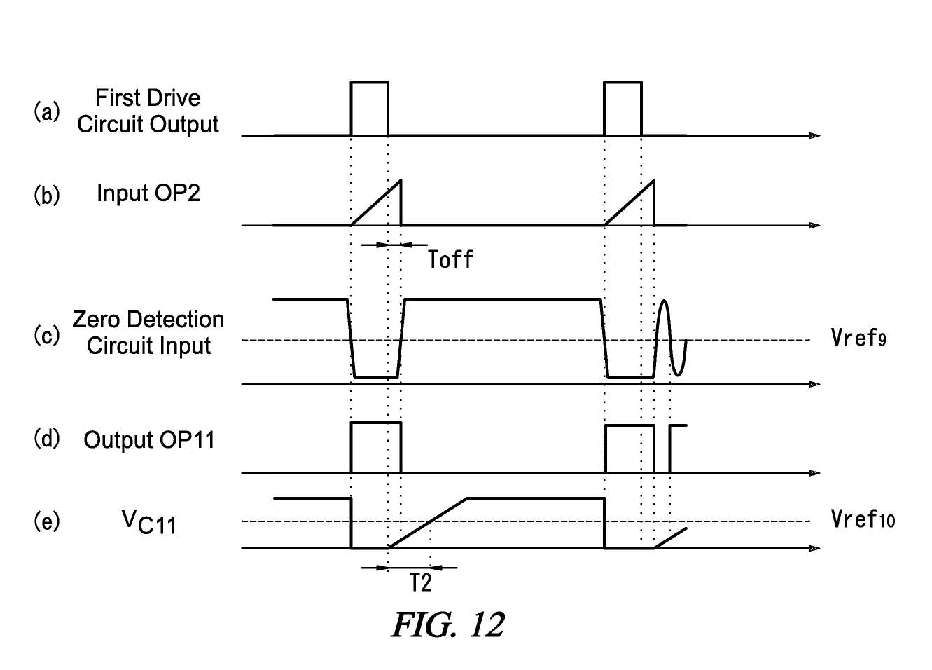

Operation of the zero current detection circuit 51 of the present embodiment is described with reference to FIG. 12. First, when the stored energy of the inductor L1 is released, i.e., the secondary winding voltage of the inductor L1 falls below the ninth reference voltage Vref9 in the off state of the switch Q1, a high level signal is outputted from the eleventh operational amplifier OP11 (see FIGS. 12(c) and (d)). Normally, during the off period of switch Q1, switch Q9 is in the off state, so that capacitor C11 is charged by third constant current source Iref3. Because the charge voltage exceeds the tenth reference voltage Vref10, a high level signal is outputted from twelfth operational amplifier OP12. Thus, the output of eleventh operational amplifier OP11, and the output of twelfth operational amplifier OP12 bring the output of AND gate AND1 to a high level, and a high level signal is provided to the set terminal of the RS flip-flop 52 to turn on switch Q1 through first drive circuit 50 (see FIG. 12(a)).

When switch Q1 is turned on, the current through switch Q1 increases, and the input voltage to operational amplifier OP2 rises. When the input voltage exceeds the predetermined value (output voltage of multiplier circuit 53), the reset terminal of RS flip-flop 52 is provided with a high level signal to turn off switch Q1 through the first drive circuit 50 after the above-described filter period Tf has passed (see FIGS. 12(a) and (b)). When switch Q1 is turned off, the output of RS flip-flop 52 becomes low, and therefore switch Q9 is turned off to charge capacitor C11 (see FIG. 12(e)).

Similarly to the first embodiment, the voltage on capacitor C11 requires the predetermined period T2 to reach the tenth reference voltage Vref10. Thus, the mask circuit 51a stops the zero signal (high level signal) from zero current detection circuit 51 during the predetermined period T2 after switch Q1 is turned off.

Note that the input voltage to second operational amplifier OP2 becomes 0 V after a delay time Toff has elapsed after the start of charging of capacitor C11 (see FIG. 12(b)). The delay time Toff is based on a delay from a point when the drive signal outputted by the first drive circuit 50 becomes low to a time when switch Q1 is actually turned off.

If the above-described filter period Tf is longer than the delay time Toff, no particular problem arises. However, if the filter period Tf is shorter than the delay time Toff, a problem may arise. That is, after the reset input has been provided to RS flip-flop 52 by the high level signal of the second operational amplifier OP2, the gate current of switch Q1 is superimposed on the input signal of second operational amplifier OP2 at the time when the drive signal from the first drive circuit 50 becomes low. If, at this point in time, the secondary winding voltage of inductor L1 has not been switched to a positive voltage, the reset input is cancelled for a moment to cause rapid or unstable switching in switch Q1, and thereby excessive stresses may be applied to switch Q1.

To prevent this, as in the first embodiment, the one shot pulse generation circuit 51b can be configured to generate a one shot pulse at the time when stored energy of the inductor L1 is released, and use the one shot pulse to turn on switch Q1. However, if the one shot pulse generation circuit 51b is used for this purpose, the circuit configuration becomes more complex.

Therefore, in the present embodiment, the predetermined period T2 in mask circuit 51a is set to be longer than the filter period Tf. For this reason, even if the gate current of switch Q1 is superimposed on the input signal of the second operational amplifier OP2 as described above, the corresponding timing is within the predetermined period T2, and therefore capacitor C11 is not sufficiently charged. Accordingly, the high level signal is not outputted from twelfth operational amplifier OP12, and during the predetermined period T2, the output of the AND gate AND 2 is constantly low, so that the set terminal of the RS flip-flop 52 is not provided with a high level signal, and therefore rapid switching can be prevented from occurring in switch Q1.

Thus, in the present embodiment, it is not necessary to provide the one shot pulse generation circuit 51b as in the first embodiment, so that the circuit configuration can be simplified, and a ballast having higher reliability with fewer failures can be achieved.

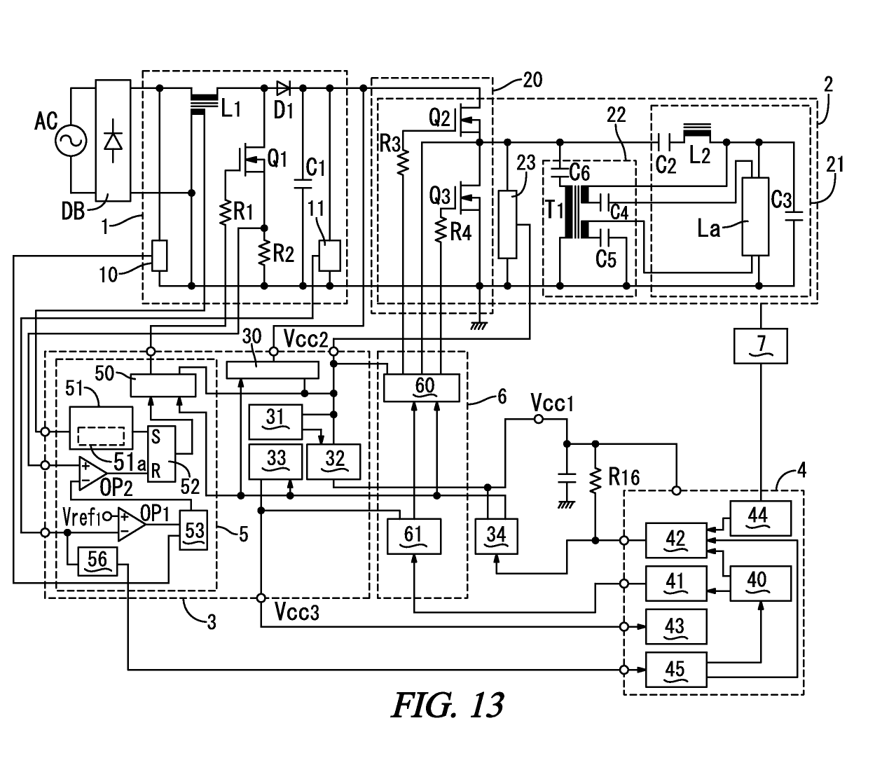

A third embodiment of the electronic ballast according to the present invention is described below with reference to FIG. 13. The basic configuration of the present embodiment is in common with the first or second embodiment, and therefore common circuits are denoted by the same reference numerals to omit description. In addition, the ballast control circuit 3 of the present embodiment may be configured such that the DC power supply control circuit 5, the starting circuit 30, the control power supply comparison circuit 31, the first control power supply generation circuit 32, and the third control power supply generation circuit 33 are formed on the same semiconductor substrate.

The present embodiment is, as illustrated in FIG. 13, provided with a voltage reduction detection circuit 56 that is provided in the DC power supply control circuit 5 and determines whether or not the output voltage of the DC power supply circuit 1 falls below a predetermined target voltage. An end of life detection circuit 7 detects an end of life condition of the discharge lamp La. A first abnormality or fault detection circuit 44 is provided in the mode control circuit 4 and disables operation of the DC power supply control circuit 5 and the inverter control circuit 6 on the basis of a result of detection by the end of life detection circuit 7. A second abnormality detection circuit 45 is provided in the mode control circuit 4 and stops operations of the DC power supply control circuit 5 and inverter control circuit 6 on the basis of a result of the detection by the voltage reduction detection circuit 56. Note that the end of life detection circuit 7 is only required to detect end of life of the discharge lamp La, and is conventionally widely known, and therefore detailed description of it is omitted here. Also, to insure starting of the discharge lamp La, abnormality or fault detection processing is not performed in the first abnormality detection circuit 45 during the preheating and starting periods.

The voltage reduction detection circuit 56 includes, as illustrated in FIG. 14, a thirteenth operational amplifier OP13 of which a non-inverting input is connected with the detection voltage of output voltage detection circuit 11 and an inverting input is connected with an eleventh reference voltage Vref11. A switch Q11 (e.g., a MOSFET) has its gate connected to the output of thirteenth operational amplifier OP13. A resistor R17 is coupled between the drain of switch Q11 and third control power supply generation circuit 33.

The voltage reduction detection circuit 56 detects the predetermined lower voltage lower than the target voltage to determine an abnormality, and transmits a result of the detection to the second abnormality detection circuit 45. Specifically, the detection voltage of the output voltage detection circuit 11 and the eleventh reference voltage Vref11 are compared in thirteenth operational amplifier OP13. If the detection voltage falls below the eleventh reference voltage Vref11, i.e., the output voltage of the DC power supply circuit 1 becomes equal to the predetermined lower voltage lower than the target voltage, a low level signal is outputted from thirteenth operational amplifier OP13. The low level signal turns off switch Q1 to output a high level signal from third control power supply generation circuit 33 to the second abnormality detection circuit 45 through the resistor 17, and thereby an abnormality or fault is determined.

Note that eleventh reference voltage Vref11 is only required to be lower than the first reference voltage Vref1 that determines the target output voltage of the DC power supply circuit 1. For example, if, under a condition that the target output voltage of the DC power supply circuit 1 is 400 V, and the first reference voltage Vref1 is 2.5 V, the case where the output voltage of the DC power supply circuit 1 is reduced to 80% of the target value is determined as the abnormality, the power supply voltage of the eleventh reference voltage Vref11 is 2.0 V.

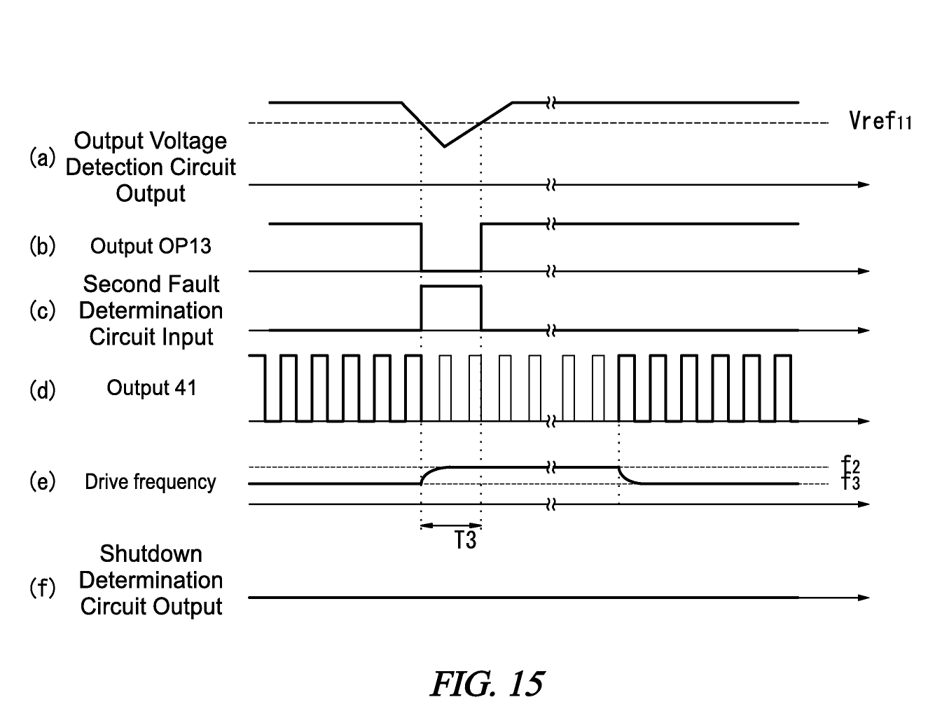

Operation of the voltage reduction detection circuit 56 and the second abnormality detection circuit 45 are described with reference to FIG. 15. First, when the output voltage of DC power supply circuit 1 is reduced, and the detection voltage of output voltage detection circuit 11 falls below the eleventh reference voltage Vref11, the output of thirteenth operational amplifier OP13 becomes low, and a high level signal is provided to second abnormality detection circuit 45 (see FIGS. 15(a), (b), and (c)). When the high level signal is received, the second abnormality detection circuit 45 determines that an abnormality has occurred in the DC power supply circuit 1, and causes a transition from the lighting period to the start time of the starting period (see FIGS. 15(d) and (e)).

If a period (corresponding to a predetermined period T3) during which the output voltage from DC power supply circuit 1 falls below the predetermined lower voltage is shorter than the starting period, the second abnormality detection circuit 45 causes a transition from the starting period to the lighting period. As described, by passing through the starting period once, even if the discharge lamp La goes out, a sufficient starting voltage is applied to the discharge lamp La if the output voltage of the DC power supply circuit 1 is restored, and therefore a shutdown of the discharge lamp La can be prevented from being maintained.

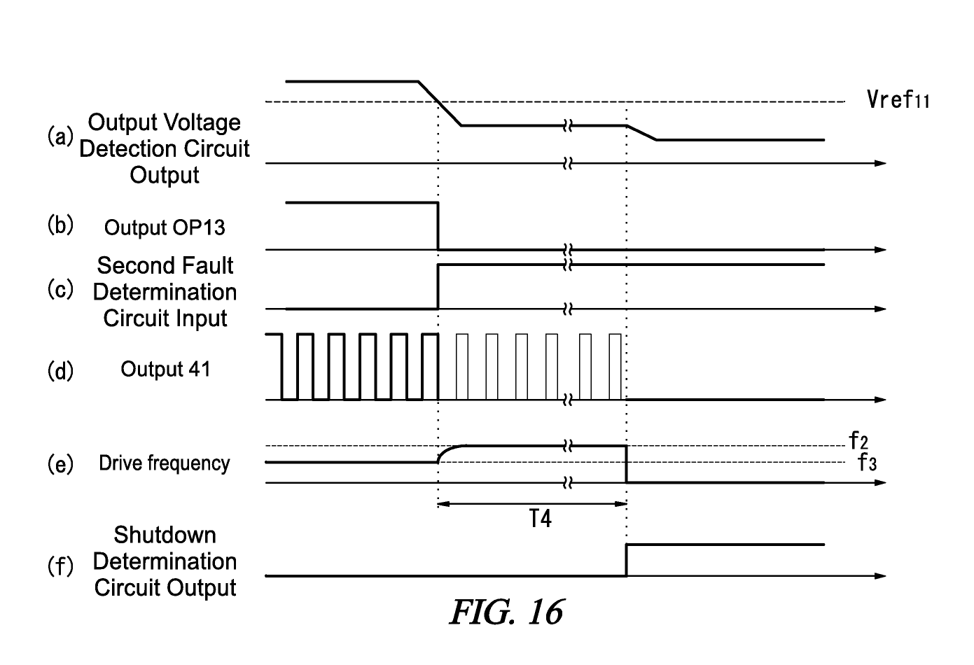

On the other hand, if the period (corresponding to a predetermined period T4, e.g., approximately 0.5 seconds) during which the output voltage of the DC power supply circuit 1 falls below the predetermined lower voltage exceeds the starting period (see FIGS. 16(a), (b), and (c)), the second abnormality detection circuit 45 instructs the shutdown detection circuit 42 to output the shutdown signal after the starting period has passed, to stop operations of first drive circuit 50 and second drive circuit 60, and maintains a shutdown or stop state (see FIGS. 16(d), (e), and (f)). That is, the second abnormality detection circuit 45 determines that a fault incapable of being restored to insure safety may have occurred, for example, a permanent abnormality is present in the input voltage of the DC power supply circuit 1, power consumption exceeding a designed capability of the DC power supply circuit 1 occurs in the load circuit 2, a failure occurs in a component in the output voltage detection circuit 11, or the like, and disables operation of the DC power supply control circuit 5 and the inverter control circuit 6 to maintain a shutdown state.

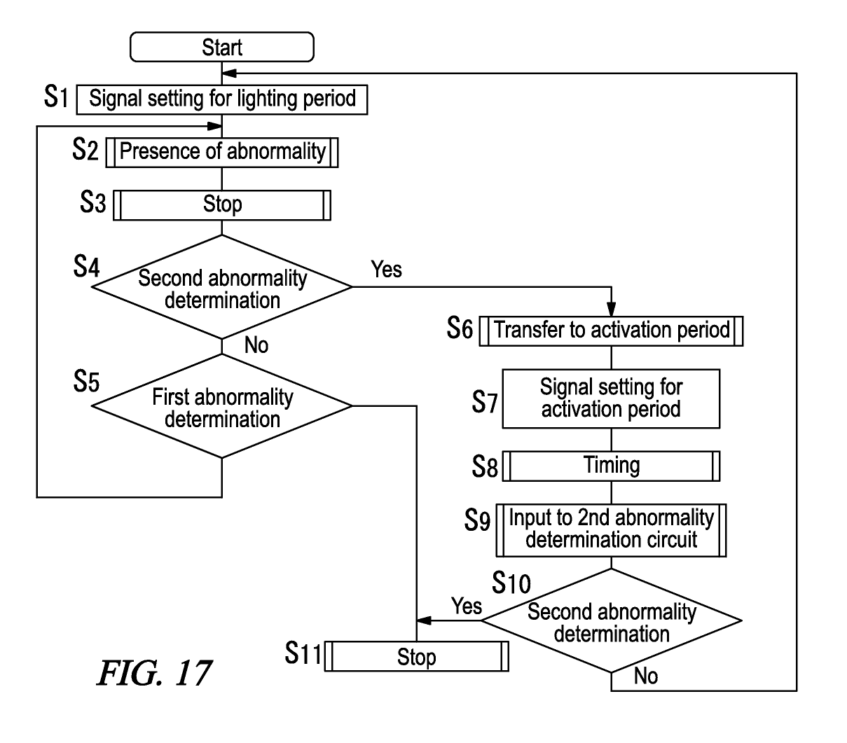

The abnormality detection processing in the mode control circuit 4 is described with reference to FIG. 17. First, a transition to the lighting period is made, and the frequency control signal is set so as to make the drive frequency equal to the frequency f3 (S1). Then, an output of the voltage reduction detection circuit 56 is provided to the second abnormality detection circuit 45 (S2), and an output of the end of life detection circuit 7 is provided to the first abnormality detection circuit 44 (S3). Note that the input to the first abnormality detection circuit 44 may be provided first, followed by the input to the second abnormality detection circuit 45. Subsequently, abnormality detection processing is performed in the second abnormality detection circuit 45 first (S4), and only if there is no abnormality found in abnormality detection processing, abnormality detection processing is performed in the first abnormality detection circuit 44 (S5).

Note that if the present embodiment operates in phase close to a resonant frequency of the resonance circuit 21, reactive current is relatively small, and therefore circuit losses can be reduced. However, the discharge lamp La is likely to go out due to a reduction in the output voltage of the DC power supply circuit 1. In such a case, if the end of life detection of the discharge lamp La, i.e., the abnormality detection processing by the first abnormality detection circuit 44 is given priority, there may arise a problem that extinguishing of the discharge lamp La is erroneously determined as a lamp end of life, to keep shutting down operations of the DC power supply control circuit 5 and the inverter control circuit 6.

Therefore, by giving priority to the abnormality detection processing by the second abnormality detection circuit 45 as described above, erroneous detection of lamp end of life is prevented.

If an abnormality is determined in the abnormality detection processing by the second abnormality detection circuit 45, a transition to the starting period is made (S6), and the frequency control signal is set so as to make the drive frequency equal to the frequency f2 (S7). Then, a time corresponding to the starting period is timed (S8), and subsequently, the output of voltage reduction detection circuit 56 is provided to the second abnormality detection circuit 45 (S9). At this time, if no abnormality is determined in the abnormality detection processing by the second abnormality detection circuit 45 (S10), a transition to the lighting period is made, and the frequency control signal is set so as to make the drive frequency equal to the frequency f3. On the other hand, if an abnormality is determined, the operations of the DC power supply control circuit 5 and the inverter control circuit 6 are shut down or stopped (S11).

As described above, if the output voltage of the DC power supply circuit 1 is temporarily reduced, the operations of the DC power supply control circuit 5 and the inverter control circuit 6 are temporarily transitioned to the starting period, whereas if the output voltage of the DC power supply circuit 1 is reduced for a period exceeding the predetermined period, a detection that a fault incapable of being restored to insure safety may occur, so that the ballast remains disabled.

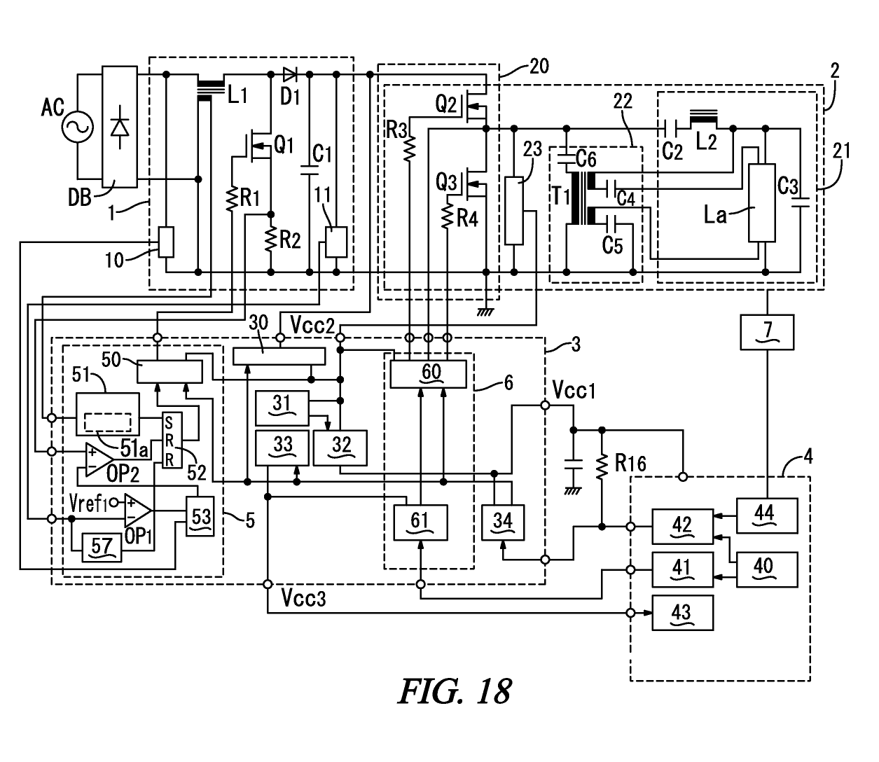

A fourth embodiment of the electronic ballast according to the present invention is described below with reference to FIG. 18. Note that the basic configuration of the present embodiment is in common with the first or second embodiment, and therefore common circuits are denoted by the same reference numerals to omit description. The present embodiment includes a voltage rise detection circuit 57 that is provided in the DC power supply control circuit 5 and determines whether or not the output voltage of the DC power supply circuit 1 exceeds a first predetermined over-voltage higher than the target voltage. This embodiment further includes a lamp end of life detection circuit 7 and a first abnormality detection circuit 44. The end of life detection circuit 7 and the first abnormality detection circuit 44 have the same configurations as those of the third embodiment 3.

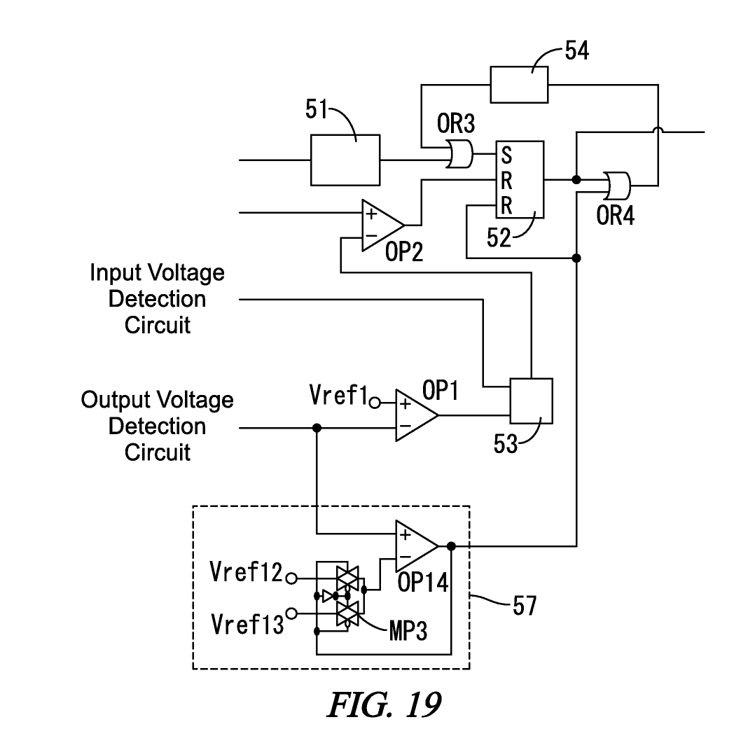

The voltage rise detection circuit 57 includes, as illustrated in FIG. 19, a third multiplexer circuit MP3 having a pair of transfer gate elements respectively connected to a twelfth reference voltage Vref12 and a thirteenth reference voltage Vref13. A fourteenth operational amplifier OP14 has its non-inverting input coupled with the detection voltage from the output voltage detection circuit 11 and its inverting input connected with the output of the third multiplexer circuit MP3. Note that the first predetermined over-voltage or thirteenth reference voltage Vref13 is larger than the second predetermined over-voltage or twelfth reference voltage Vref12. The output of fourteenth operational amplifier OP14 is coupled to reset terminal of RS flip-flop 52, and also to one of inputs of an OR gate OR4. Also, the other input of OR gate OR4 is connected with an output of the RS flip-flop 52, and an output of the OR gate OR4 is connected to the restart circuit 54.

The restart circuit 54 starts timing when the output of OR gate OR4 becomes low, and when the elapsed time exceeds a predetermined period Tr, outputs a high level signal. Then, the high level signal is provided to the set terminal of RS flip-flop 52 through OR gate OR3 to thereby turn on switch Q1 through the first drive circuit 50, and operation of the DC power supply control circuit 5 is restarted.

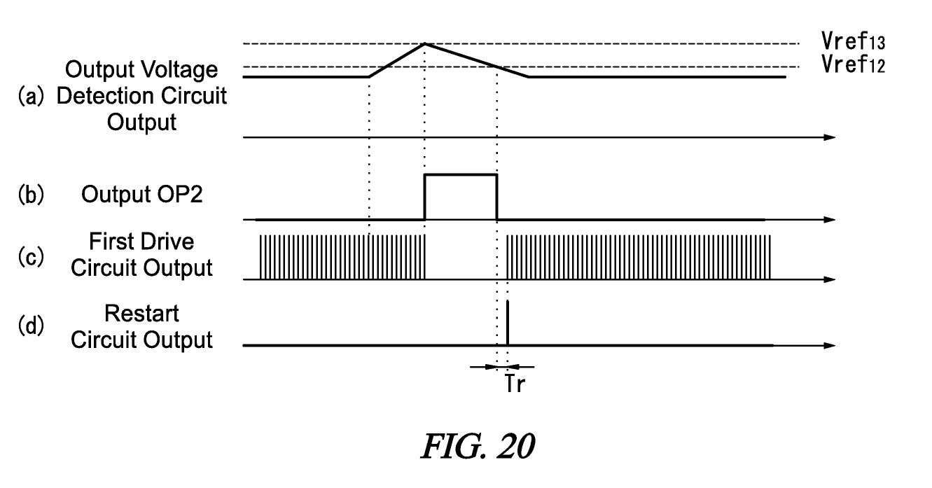

Operation of the voltage rise detection circuit 57 is described with reference to FIG. 20. When the voltage rise detection circuit 57 detects the first predetermined over-voltage is higher than the target voltage to determine an abnormality, it disables or stops operation of the DC power supply control circuit 5. Specifically, the detection voltage of the output voltage detection circuit 11 and the thirteenth reference voltage Vref13 are compared in the fourteenth operational amplifier OP14. If the detection voltage exceeds the thirteenth reference voltage Vref13, a high level signal is outputted from the fourteenth operational amplifier OP14. Then, the high level signal is provided to the reset terminal of the RS flip-flop 52 to turn off switch Q1 through the first drive circuit 50, and operation of the DC power supply control circuit 5 is stopped (see FIGS. 20(a), (b), and (c)).

Note that the output voltage of the third multiplexer circuit MP3 is equal to the thirteenth reference voltage Vref13 when the output of fourteenth operational amplifier OP14 is low, whereas when the output of fourteenth operational amplifier OP14 becomes high, i.e., the output voltage of DC power supply circuit 1 becomes the first predetermined over-voltage higher than the target voltage, the output voltage of third multiplexer circuit MP3 is switched to the twelfth reference voltage Vref12. Then, as the operation of DC power supply control circuit 5 is stopped, the output voltage of the DC power supply circuit 1 falls, and when the detection voltage of the output voltage detection circuit 11 falls below the twelfth reference voltage Vref12, i.e., below the second predetermined over-voltage, the output of fourteenth operational amplifier OP14 becomes low (see FIG. 20(b)). At this time, the output of RS flip-flop 52 is also low, and therefore the output of OR gate OR4 becomes low to start the timing in the restart circuit 54. Then, when the elapsed time exceeds the predetermined period Tr, a high level signal is outputted from the restart circuit 54, and operation of the DC power supply control circuit 5 is restarted by the high level signal (see FIGS. 20(c) and (d)).

Conventionally, control is performed such that when the output voltage of the DC power supply circuit 1 exceeds a predetermined over-voltage, operation of the DC power supply control circuit 5 is stopped, and when the time elapsed in the restart circuit 54 exceeds the predetermined period Tr, operation is restarted. In this case, the time required from the stop of operation of the DC power supply control circuit 5 to stabilization of the output voltage should be assumed to set the predetermined period Tr (e.g., 100 to 200 μs) in the restart circuit 54. The predetermined period Tr is determined by the capacitance of a capacitor provided on a chip constituting the restart circuit 54, and therefore to set the predetermined period Tr longer, the capacitance of the capacitor should be increased, which leads to a problem that a chip area is increased to increase the size of the restart circuit 54.

Therefore, in the present embodiment, as described above, in the voltage rise detection circuit 57, when the DC power supply control circuit 5 is in operation, the thirteenth reference voltage Vref13 and the detection voltage of the output voltage detection circuit 11 are compared to determine whether or not the output voltage of the DC power supply circuit 1 exceeds the first predetermined over-voltage higher than the target voltage. On the other hand, when the DC power supply control circuit 5 is not in operation, the twelfth reference voltage Vref12 and the detection voltage of the output voltage detection circuit 11 are compared to determine whether or not the output voltage of the DC power supply circuit 1 falls to around the target voltage.

Thus, it is only necessary to time the predetermined period Tr in the restart circuit 54 from a point in time when the output voltage falls to around the target voltage while the DC power supply control circuit 5 is not in operation, and therefore the predetermined period Tr can be made significantly shorter as compared with the conventional case where the timing is performed in the restart circuit 54 from a point in time when operation of the DC power supply control circuit 5 is stopped. Accordingly, the capacitance of the capacitor that sets the predetermined period Tr can be small, and therefore the chip area can be reduced to miniaturize the restart circuit 54.

As described above, the present embodiment can miniaturize the circuit to achieve an electronic ballast having higher reliability with fewer failures. Note that the present embodiment may be combined with the configurations of the voltage reduction detection circuit 56 and the second abnormality detection circuit 45 described in the third embodiment. In such a case, a device having high safety with fewer failures can be achieved.

Thus, although there have been described particular embodiments of the present invention of a new and useful electronic ballast input voltage fault control, it is not intended that such references be construed as limitations upon the scope of this invention except as set forth in the following claims.

What is claimed is:

1. A electronic ballast comprising:
a DC power supply circuit having at least one inductor and a switch connected in series with the inductor, the DC power supply circuit, by operation of the switch to cause storage and release of energy from the inductor, is functional to convert an input ripple voltage to a DC output voltage;
a load circuit coupled to receive the DC output voltage from the DC power supply circuit and functional to supply operating power to a load when a load is connected to the load circuit;
an output voltage detection circuit coupled to detect the DC output voltage of the DC power supply circuit; and
a DC power supply control circuit that is functionally coupled to the switch in the DC power supply circuit and to the output voltage detection circuit, the DC power supply circuit being functional to turn the switch on and off in response to detection by the output voltage detection circuit to thereby control the output voltage of the DC power supply circuit to a predetermined magnitude; and
the DC power supply circuit further comprises
a zero current detection circuit that, when current through the inductor becomes equal to or less than a predetermined current value, outputs a zero signal,
a peak current detection circuit that, when current through the switch in the DC power supply circuit becomes equal to or greater than the predetermined current value, outputs a peak signal,
a drive circuit that turns on the switch of the DC power supply circuit in response to the zero signal, and switches off the switch of the DC power supply circuit in response to the peak signal, and wherein
the zero signal detection circuit comprises a mask circuit that stops the zero signal from being outputted to the drive circuit for a predetermined period after the current through the inductor has become equal to or less than the predetermined current value.

2. The electronic ballast according to claim 1, further comprising:
the DC power supply control circuit further comprises a filter circuit that stops the peak signal from being outputted to the drive circuit for a predetermined period after the current through the switch of the DC power supply circuit has become equal to or more than the predetermined current value; and
the predetermined period set in the mask circuit is set longer than the predetermined period set in the filter circuit.

3. The electronic ballast according to claim 1, wherein
the load is a discharge lamp; and
the load circuit comprises
an inverter control circuit comprising at least one inverter control switch, the inverter control circuit being functional to control the inverter control switch to convert the output voltage of the DC power supply circuit to a high frequency voltage,
a voltage reduction detection circuit that is provided in the DC power supply control circuit and determines whether or not the output voltage of the DC power supply circuit falls below a predetermined lower voltage lower than the predetermined voltage,
a sequence control circuit that performs at least sequence control of two periods, the two periods being a starting period for controlling the inverter control circuit so as to supply power necessary for starting a discharge lamp, and a lighting period for controlling the inverter control circuit so as to supply power necessary to maintain lighting of a the discharge lamp, and wherein
upon the detection being made in the voltage reduction detection circuit that the output voltage falls below the predetermined lower voltage, the sequence control circuit causes a transition to the starting period, and to transition the lighting period after a predetermined time has passed.

4. The electronic ballast of claim further comprising:
the DC power supply control circuit comprises
a voltage rise detection circuit that determines whether or not the output voltage of the DC power supply circuit exceeds a first predetermined overvoltage higher than the predetermined voltage, and upon the detection that the output voltage exceeds the first predetermined overvoltage being made, turns off a switch of the DC power supply control circuit through the drive circuit,
a restart circuit that times an off time of the switch of the DC power supply control circuit, and upon the time exceeding a predetermined period, turns on the switch of the DC power supply control circuit through the drive circuit, wherein
the voltage rise detection circuit determines, upon the switch of the DC power supply circuit being in an off state, whether or not the output voltage of the DC power supply circuit falls below a second predetermined overvoltage lower than the first predetermined overvoltage, and
the restart circuit times the off time of the switch of the DC power supply control circuit from a point when the detection that the output voltage of the DC power supply circuit falls below the second predetermined overvoltage is made in the voltage rise detection circuit.
